(19) United States
(12) Patent Application Publication
(10) Pub. No.: US 2026/0277088 A1
(43) Pub. Date: Sep. 17, 2026

(54) OPTICAL MODULE AND PROJECTOR

(71) Applicant: SEIKO EPSON CORPORATION, Tokyo (JP)

(72) Inventor: Keita TSUKIOKA, MATSUMOTO-SHI NAGANO-KEN (JP)

(21) Appl. No.: 19/562,937

(22) Filed: Mar. 11, 2026

(30) Foreign Application Priority Data
Mar. 12, 2025 (JP) 2025-039170

(51) Int. Cl. G03B 21/20; G03B 21/00; G03B 21/14; G03B 21/16

(52) U.S. Cl. CPC G03B 21/2046; G03B 21/006; G03B 21/145; G03B 21/16; G03B 21/2033

(57) ABSTRACT

An optical module includes a first light source module emitting a first light, a support member, and a positioning portion positioning the first light source module, the first light source module has a first light source including a first light emitting element and a first substrate, and a holding member, the holding member has an attachment surface in contact with the support member, the support member has a position adjustment surface in contact with the attachment surface for adjusting a relative position between the first light source module and the support member, the positioning portion includes a first opposing portion and a second opposing portion, and when the relative position between the first light source module and the support member is determined, the first opposing portion and the second opposing portion at least partially overlap when viewed from a direction along an optical axis direction of the first light.

The present application is based on, and claims priority from JP Application Serial Number 2025-039170, filed Mar. 12, 2025, the disclosure of which is hereby incorporated by reference herein in its entirety.

### BACKGROUND

### 1. Technical Field

The present disclosure relates to an optical module and a projector.

### 2. Related Art

There is a known projector of related art including a light source that emits a light, a light modulation device that modulates the light emitted from the light source in accordance with image information to generate an image light, and a projection optical system that enlarges and projects the image light emitted from the light modulation device onto a projection surface such as a screen.

JP-A-2000-180962 discloses a projector including an LED light source that emits a light, a block-shaped light guide element that emits the light emitted from the LED light source from an emission end with uniform brightness, a condenser lens that forms a light source image of the light emitted from the light guide element at the incident pupil position of a projection lens, a light modulation element that generates an image light, and the projection lens.

JP-A-2000-180962 is an example of the related art.

In the projector described above, it is important to simply and accurately align the optical axis of the light emitted from the LED light source with the light modulation element in order to improve the light use efficiency and the illuminance unevenness. Therefore, it is required to provide a new technique capable of simply and accurately aligning the optical axis of the light emitted from the LED light source and the light modulation element.

### SUMMARY

An optical module according to an aspect of the present disclosure includes a first light source module having a first light source that emits a first light, a support member that supports the first light source module, a positioning portion that positions the first light source module with respect to the support member, and a first light modulation unit that modulates the first light incident from the first light source module, wherein the first light source module has a first light source including a first light emitting element that emits the first light, and a first substrate on which the first light emitting element is mounted, and a holding member fixed to the first substrate, the holding member has an attachment portion that extends along a surface direction of the first substrate and attaches the first light source module to the support member, the attachment portion has an attachment surface in contact with the support member, the support member has a position adjustment surface in contact with the attachment surface for adjusting a relative position between the first light source module and the support member, the positioning portion includes a first opposing portion provided on the attachment surface and a second opposing portion provided at a position corresponding to the first opposing portion on the position adjustment surface, and when the relative position between the first light source module and the support member is determined, the first opposing portion and the second opposing portion at least partially overlap each other when viewed in a direction along an optical axis direction of the first light.

An optical module according to another aspect of the present disclosure includes a first light source module having a first light source that emits a first light, a support member that supports the first light source module, and a first light modulation unit that modulates the first light incident from the first light source module, wherein the first light source module has a first light source including a first light emitting element that emits the first light, and a first substrate on which the first light emitting element is mounted, and a holding member fixed to the first substrate, the holding member has an attachment portion that extends along a surface direction of the first substrate and attaches the first light source module to the support member, the attachment portion includes an attachment surface in contact with the support member, the support member has a fixing surface in contact with the attachment surface, to which the first light source module is fixed, and the holding member and the support member are directly fixed to each other via the attachment surface and the fixing surface.

A projector according to an aspect of the present disclosure includes the optical module according to any one of the aspects described above.

### BRIEF DESCRIPTION OF THE DRAWINGS

FIG. 1 is a plan view showing a schematic configuration of a projector according to an embodiment.

FIG. 2 is a perspective view showing an overall configuration of a support member.

FIG. 3 is an exploded perspective view of a green light source module.

FIG. 4 is a plan view showing a light source.

FIG. 5 is a plan view of an optical module with a plate material of a heat dissipation member removed.

FIG. 6 is a perspective view of the support member.

FIG. 7 is a perspective view showing the heat dissipation member and the support member.

FIG. 8 is a cross-sectional view taken along line VIII in FIG. 7.

FIG. 9 is a flowchart showing an assembly method for the optical module.

### DESCRIPTION OF EMBODIMENTS

An embodiment of the present disclosure will be described below with reference to the drawings.

A projector according to the present embodiment is an example of a liquid crystal projector using liquid crystal panels as light modulation devices.

In the following drawings, some component elements may be shown at different dimensional scales for clarity of the respective component elements.

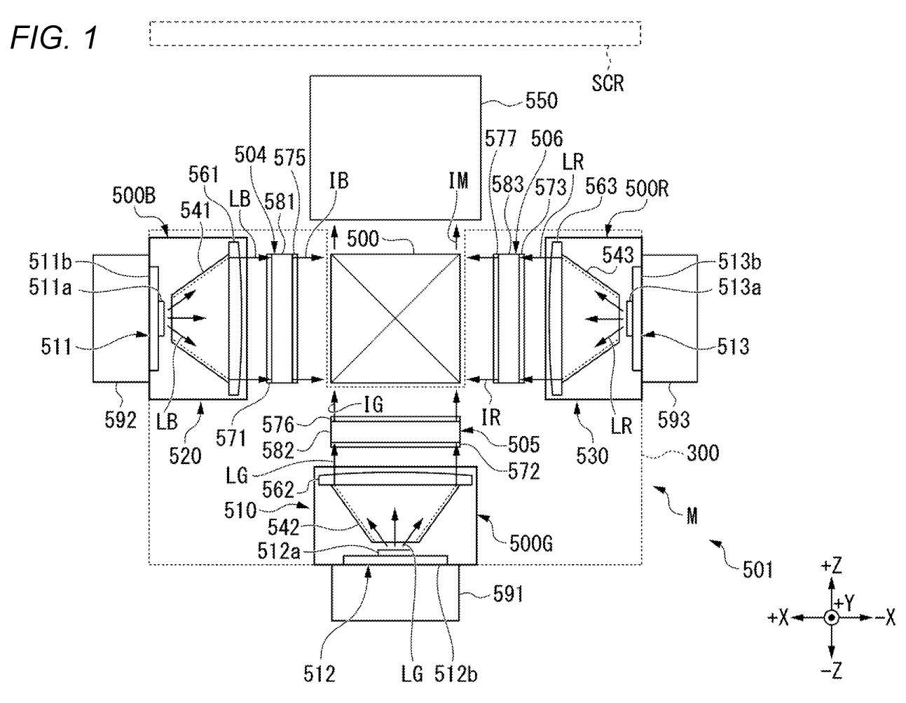

FIG. 1 is a plan view showing a schematic configuration of the projector according to the embodiment.

As illustrated in FIG. 1, a projector 501 is an image display apparatus including three liquid crystal panels as the light modulation devices, and is the so-called 3-LCD projector. The projector 501 includes an optical module M and a projection optical system 550. The optical module M includes a green light source module (first light source module) 500G, a blue light source module (second light source module) 500B, a red light source module (third light source module) 500R, a green light modulation unit (first light modulation unit) 505, a blue light modulation unit (second light modulation unit) 504, a red light modulation unit (third light modulation unit) 506, a green heat sink 591, a blue heat sink 592, a red heat sink 593, a light combining element 500, and a support member 300.

The green heat sink 591 is a heat dissipation member that dissipates heat generated from the green light source module 500G. The blue heat sink 592 is a heat dissipation member that dissipates heat generated from the blue light source module 500B. The red heat sink 593 is a heat dissipation member that dissipates heat generated from the red light source module 500R.

In FIGS. 1 to 3, 7, and 8, the configurations of the green heat sink 591, the blue heat sink 592, and the red heat sink 593 are schematically illustrated. The green heat sink 591, the blue heat sink 592, and the red heat sink 593 may dissipate heat using, for example, heat pipes or the like.

The support member 300 is a member for holding the unitized green light source module 500G, blue light source module 500B, and red light source module 500R. The support member 300 will be described in detail later.

The green light source module 500G, the blue light source module 500B, and the red light source module 500R have the same configuration except for the corresponding colors of light.

First, the green light source module 500G is described. The green light source module 500G includes a green light source (first light source) 512, a green light guide element 542, and a green parallelizing element 562.

The green light source 512 includes a green light emitting element (first light emitting element) 512a and a green substrate (first substrate) 512b on which the green light emitting element 512a is mounted.

The green substrate 512b includes the green light emitting element 512a. The green light emitting element 512a emits a green light (first light) LG. In the following description, a direction parallel to the optical axis of the green light LG emitted from the green light emitting element 512a is a Z direction (optical axis direction). One side in the Z direction is referred to as a -Z side, and the opposite side to the -Z side in the Z direction is referred to as a +Z side. A direction orthogonal to the Z direction within a plane including the optical axis of the green light LG is an X direction. One side in the X direction is referred to as a -X side, and the opposite side to the -X side in the X direction is referred to as a +X side. A direction orthogonal to the Z direction and the X direction is a Y direction. The green light LG emitted from the green light emitting element 512a travels to the +Z side along the Z direction.

The green light emitting element 512a is supported by the green substrate 512b. The green substrate 512b is a plate parallel to a plane including the X direction and the Y direction.

The green light emitting element 512a is provided on the plate surface at the +Z side in the green substrate 512b. The light emitting surface of the green light emitting element 512a is a surface at the +Z side. The green light emitting element 512a emits the green light LG in a green wavelength band in the visible wavelength band. The green light LG is emitted to the +Z side with an axis passing through the center of the light emitting surface of the green light emitting element 512a and being parallel to the Z direction as a center. The green wavelength band is, for example, a wavelength band ranging from 500 nm to 600 nm. Since the green wavelength band is easy for the human eyes to recognize, a large amount of light is required for projection onto a screen SCR.

The green light guide element 542 is provided in the optical path of the green light LG emitted from the green light emitting element 512a, and is disposed at the +Z side of the green light emitting element 512a.

The green parallelizing element 562 is provided in the optical path of the green light LG emitted from the green light guide element 542. The green parallelizing element 562 parallelizes the green light LG emitted from the green light guide element 542 along the Z direction.

The green light modulation unit (first light modulation unit) 505 includes a green light incident-side polarization element 572, a green light modulation element 582, and a green light exiting-side polarization element 576. The green light modulation unit 505 is provided in the optical path of the green light LG emitted from the green parallelizing element 562. The green light modulation unit 505 is disposed to face the green light source module 500G supported by the support member 300. The green light modulation unit 505 modulates the green light LG incident from the green light source 512.

The green light incident-side polarization element 572 is disposed at the +Z side of the green parallelizing element 562. The green light incident-side polarization element 572 emits predetermined polarized light of the green light LG emitted from the green parallelizing element 562 to the +Z side along the Z direction. The green light incident-side polarization element 572 is, for example, a reflective or absorptive polarizer. The green light incident-side polarization element 572 is supported by the support member 300.

The green light modulation element 582 is disposed at the +Z side of the green light incident-side polarization element 572. The green light modulation element 582 modulates the green light LG emitted from the green light incident-side polarization element 572. The green light modulation element 582 is, for example, a transmissive liquid crystal panel. The liquid crystal panel forming the green light modulation element 582 generates a green image light IG by modulating the light based on green image information. The green light modulation element 582 emits the generated image light IG to the +Z side along the Z direction.

The green light exiting-side polarization element 576 is disposed at the +Z side of the green light modulation element 582. The green light exiting-side polarization element 576 emits predetermined polarized light of the image light IG emitted from the green light modulation element 582 to the +Z side along the Z direction. The green light exiting-side polarization element 576 is, for example, a reflective or absorptive polarizer.

Next, the blue light source module 500B will be described. The blue light source module (second light source module) 500B includes a blue light source (second light source) 511, a blue light guide element 541, and a blue parallelizing element 561. The blue light source module 500B has the same configuration as the green light source module 500G.

The blue light source 511 includes a blue light emitting element (second light emitting element) 511a and a blue substrate (second substrate) 511b on which the blue light emitting element 511a is mounted.

The blue substrate 511b has the blue light emitting element 511a. The blue light emitting element 511a emits a blue light (second light) LB. The blue light LB emitted from the blue light emitting element 511a travels to the -X side along the X direction.

The blue light emitting element 511a is supported by the blue substrate 511b. The blue substrate 511b is a plate parallel to a plane including the Y direction and the Z direction. The configuration of the blue substrate 511b is the same as that of the green substrate 512b.

The blue light emitting element 511a is provided on a plate surface at the -X side in the blue substrate 511b. The light emitting surface of the blue light emitting element 511a is a surface at the -X side. The blue light emitting element 511a emits the blue light LB in a blue wavelength band in the visible wavelength band. The blue light LB is emitted to the -X side with an axis passing through the center of the light emitting surface of the blue light emitting element 511a and being parallel to the X direction as a center. The blue wavelength band is, for example, a wavelength band ranging from 420 nm to 500 nm. The light in the blue wavelength band has the shortest wavelength of the color lights used in the 3-LCD projector, and therefore has higher energy.

The blue light guide element 541 is provided in the optical path of the blue light LB emitted from the blue light emitting element 511a and is disposed at the -X side of the blue light emitting element 511a. The configuration of the blue light guide element 541 is the same as the green light guide element 542, and has a light guide path that guides the blue light LB.

The blue parallelizing element 561 is provided in the optical path of the blue light LB emitted from the blue light guide element 541. The blue parallelizing element 561 parallelizes the blue light LB emitted from the blue light guide element 541 along the X direction.

The blue light modulation unit (second light modulation unit) 504 includes a blue light incident-side polarization element 571, a blue light modulation element 581, and a blue light exiting-side polarization element 575. The blue light modulation unit 504 is provided in the optical path of the blue light LB emitted from the blue parallelizing element 561. The blue light modulation unit 504 is disposed to face the blue light source module 500B supported by the support member 300. The blue light modulation unit 504 modulates the blue light LB incident from the blue light source 511.

The blue light incident-side polarization element 571 is disposed at the -X side of the blue parallelizing element 561. The blue light incident-side polarization element 571 emits predetermined polarized light of the blue light LB emitted from the blue parallelizing element 561 toward the -X side along the X direction. The blue light incident-side polarization element 571 is, for example, a reflective or absorptive polarizer. The blue light incident-side polarization element 571 is supported by the support member 300.

The blue light modulation element 581 is disposed at the -X side of the blue light incident-side polarization element 571. The blue light modulation element 581 modulates the blue light LB emitted from the blue light incident-side polarization element 571. The blue light modulation element 581 is, for example, a transmissive liquid crystal panel. The liquid crystal panel forming the blue light modulation element 581 generates a blue image light IB by modulating the light based on blue image information. The blue light modulation element 581 emits the generated image light IB to the -X side along the X direction.

The blue light exiting-side polarization element 575 is disposed at the -X side of the blue light modulation element 581. The blue light exiting-side polarization element 575 emits predetermined polarized light of the image light IB emitted from the blue light modulation element 581 to the -X side along the X direction. The blue light exiting-side polarization element 575 is, for example, a reflective or absorptive polarizer.

Next, the red light source module 500R will be described. The red light source module (third light source module) 500R includes a red light source (third light source) 513, a red light guide element 543, and a red parallelizing element 563. The red light source module 500R has the same configuration as the green light source module 500G.

The red light source 513 includes a red light emitting element (third light emitting element) 513a and a red substrate (third substrate) 513b on which the red light emitting element 513a is mounted.

The red substrate 513b has the red light emitting element 513a. The red light emitting element 513a emits a red light (third light) LR. The red light LR emitted from the red light emitting element 513a travels to the +X side along the X direction.

The red light emitting element 513a is supported by the red substrate 513b. The red substrate 513b is a plate parallel to a plane including the Y direction and the Z direction. The configuration of the red substrate 513b is the same as that of the green substrate 512b.

The red light emitting element 513a is provided on the plate surface at the +X side in the red substrate 513b. The light emitting surface of the red light emitting element 513a is a surface at the +X side. The red light emitting element 513a emits the red light LR in a red wavelength band in the visible wavelength band. The red light LR is emitted to the +X side with an axis passing through the center of the light emitting surface of the red light emitting element 513a and being parallel to the X direction as a center. The red wavelength band is, for example, a wavelength band ranging from 610 nm to 700 nm.

The red light guide element 543 is provided in the optical path of the red light LR emitted from the red light emitting element 513a and is disposed at the +X side of the red light emitting element 513a. The configuration of the red light guide element 543 is the same as that of the green light guide element 542, and has a light guide path that guides the red light LR.

The red parallelizing element 563 is provided in the optical path of the red light LR emitted from the red light guide element 543. The red parallelizing element 563 parallelizes the red light LR emitted from the red light guide element 543 along the X direction.

The red light modulation unit (third light modulation unit) 506 includes a red light incident-side polarization element 573, a red light modulation element 583, and a red light exiting-side polarization element 577. The red light modulation unit 506 is provided in the optical path of the red light LR emitted from the red parallelizing element 563. The red light modulation unit 506 is disposed to face the red light source module 500R supported by the support member 300. The red light modulation unit 506 modulates the red light LR incident from the red light source 513.

The red light incident-side polarization element 573 is disposed at the +X side of the red parallelizing element 563. The red light incident-side polarization element 573 emits predetermined polarized light of the red light LR emitted from the red parallelizing element 563 toward the +X side along the X direction. The red light incident-side polarization element 573 is, for example, a reflective or absorptive polarizer. The red light incident-side polarization element 573 is supported by the support member 300.

The red light modulation element 583 is disposed at the +X side of the red light incident-side polarization element 573. The red light modulation element 583 modulates the red light LR emitted from the red light incident-side polarization element 573. The red light modulation element 583 is, for example, a transmissive liquid crystal panel. The liquid crystal panel forming the red light modulation element 583 generates a red image light IR by modulating the light based on red image information. The red light modulation element 583 emits the generated image light IR to the +X side along the X direction.

The red light exiting-side polarization element 577 is disposed at the +X side of the red light modulation element 583. The red light exiting-side polarization element 577 emits predetermined polarized light of the image light IR emitted from the red light modulation element 583 to the +X side along the X direction. The red light exiting-side polarization element 577 is, for example, a reflective or absorptive polarizer.

The light combining element 500 is disposed in a region where the optical path of the blue image light IB emitted from the blue light source module 500B, the optical path of the green image light IG emitted from the green light source module 500G, and the optical path of the red image light IR emitted from the red light source module 500R intersect one another. The light combining element 500 combines the image lights IB, IG, and IR emitted from the blue light exiting-side polarization element 575 of the blue light modulation unit 504, the green light exiting-side polarization element 576 of the green light modulation unit 505, and the red light exiting-side polarization element 577 of the red light modulation unit 506, and emits a generated image light IM to the +Z side along the Z direction.

The projection optical system 550 is disposed in the optical path of the image light IM emitted from the light combining element 500. The projection optical system 550 projects the image light IM onto the screen SCR, and enlarges and displays the images input to the blue light modulation element 581, the green light modulation element 582, and the red light modulation element 583 on the screen SCR.

Next, the structure of the support member 300 will be described in more detail.

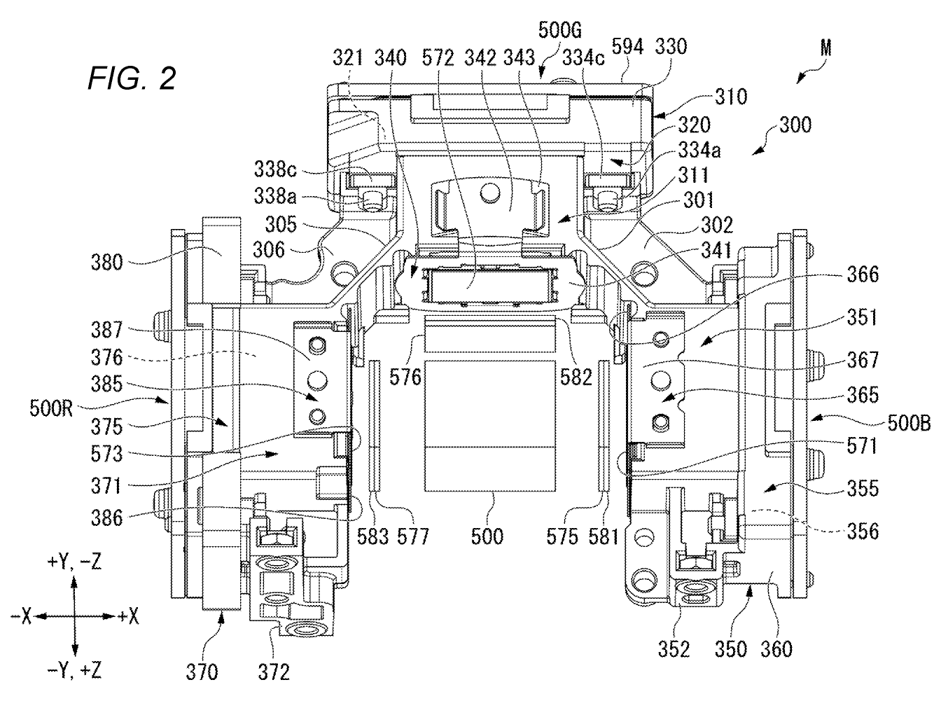

FIG. 2 is a perspective view showing an overall configuration of the support member. FIG. 2 illustrates a state in which the support member 300 is slightly inclined about the X axis and the Y axis is slightly inclined to the -Z side. As illustrated in FIG. 2, the support member 300 holds the green light source module 500G, the blue light source module 500B, and the red light source module 500R. The support member 300 includes a green fixing section (first fixing section) 310 that fixes the green light source module 500G, a blue fixing section (second fixing section) 350 that fixes the blue light source module 500B, a red fixing section (third fixing section) 370 that fixes the red light source module 500R, a first coupling portion 301, and a second coupling portion 305.

The green fixing section 310, the blue fixing section 350, and the red fixing section 370 are each formed in a box shape and are disposed so as to surround the light combining element 500. The green fixing section 310 is disposed at the -Z side of the light combining element 500. The blue fixing section 350 and the red fixing section 370 are disposed to face each other via the light combining element 500. The blue fixing section 350 is disposed at the +X side of the light combining element 500. The red fixing section 370 is disposed at the -X side of the light combining element 500.

The green fixing section 310 and the blue fixing section 350 are coupled by the first coupling portion 301. The green fixing section 310 and the red fixing section 370 are coupled by the second coupling portion 305. Thus, the green fixing section 310, the blue fixing section 350, and the red fixing section 370 are integrally formed. The first coupling portion 301 and the second coupling portion 305 will be described in detail later.

The green fixing section 310, the blue fixing section 350, and the red fixing section 370 have the same configuration except for the corresponding colors of light. First, the green fixing section 310 is described. The green fixing section 310 has a green housing portion 311, a fixing portion 320, and a green polarization element holding portion 340.

The green housing portion 311 is provided at the +Z side of the green fixing section 310. The green housing portion 311 opens in the Z direction along the optical axis of the green light LG and is formed in a box shape. The green light source module 500G is housed inside the green housing portion 311.

The fixing portion 320 is provided at the -Z side of the green housing portion 311. The fixing portion 320 is formed in a rectangular shape having a thickness in the Z direction. The fixing portion 320 has a position adjustment surface 321 and a peripheral wall portion 330. A holding member 101, which will be described later, is attached to the fixing portion 320. The fixing portion 320 will be described in detail later.

The green polarization element holding portion 340 is provided at the +Z side of the green housing portion 311. The green polarization element holding portion 340 is a member that holds the green light incident-side polarization element 572.

The green polarization element holding portion 340 has a holding plate 341 and a fixing portion 342.

The holding plate 341 is a plate in which the green light incident-side polarization element 572 is held at the center. The holding plate 341 is parallel to a plane including the X direction and the Y direction. The holding plate 341 covers the opening at the +Z side of the green housing portion 311.

The fixing portion 342 is a member that fixes the green polarization element holding portion 340 to the green housing portion 311. The fixing portion 342 is formed to be bent from the end at the +Y side of the holding plate 341 toward the -Z side. The fixing portion 342 fixes the green polarization element holding portion 340 to the green housing portion 311 on the side surface at the +Y side of the green housing portion 311.

An adjustment member 343 that fixes the green polarization element holding portion 340 so as to be adjustable in angle is formed on the side surface at the +Y side of the green housing portion 311. The adjustment member 343 is formed in a semicircular shape protruding toward the +Y side. The fixing portion 342 is coupled to the green housing portion 311 via the adjustment member 343.

The green polarization element holding portion 340 is fixed to the green housing portion 311 so as to be adjustable in angle by the adjustment member 343. The holding plate 341 rotates about the fixing portion 342 with the Z axis as a rotation axis. Therefore, the green light incident-side polarization element 572 held by the holding plate 341 can rotate about the fixing portion 342 with the Z axis as a rotation axis.

Thus, since the green light incident-side polarization element 572 can match the rotation angles of the green light modulation element 582 and the green light exiting-side polarization element 576 provided at the light combining element 500 side, the contrast on the screen SCR can be enhanced.

The green light modulation element 582 and the green light exiting-side polarization element 576 are fixed to a holding member (not illustrated) provided at the light combining element 500 side.

Next, the blue fixing section 350 will be described. The blue fixing section 350 has a blue housing portion 351, a fixing portion 355, and a blue polarization element holding portion 365.

The blue housing portion 351 is provided at the -X side of the blue fixing section 350. The blue housing portion 351 opens in the X direction along the optical axis of the blue light LB and is formed in a box shape. The blue light source module 500B is housed inside the blue housing portion 351.

A coupling portion 352 coupled to the light combining element 500 and the projection optical system 550 is provided at the +Z side of the blue housing portion 351. The coupling portion 352 is fastened and fixed to a holding member (not illustrated) that holds the light combining element 500 and the projection optical system 550 together with the blue light modulation element 581 and the blue light exiting-side polarization element 575.

The fixing portion 355 is provided at the +X side of the blue housing portion 351. The fixing portion 355 is formed in a rectangular shape having a thickness in the X direction. The fixing portion 355 has a position adjustment surface 356 and a peripheral wall portion 360. The fixing portion 355 has the same configuration as the fixing portion 320 of the green fixing section 310.

The blue polarization element holding portion 365 is provided at the -X side of the blue housing portion 351. The blue polarization element holding portion 365 is a member that holds the blue light incident-side polarization element 571.

The blue polarization element holding portion 365 includes a holding plate 366 and a fixing portion 367.

The holding plate 366 is a plate in which the blue light incident-side polarization element 571 is held at the center. The holding plate 366 is parallel to a plane including the Y direction and the Z direction. The holding plate 366 covers the opening at the -X side of the blue housing portion 351.

The fixing portion 367 is a member that fixes the blue polarization element holding portion 365 to the blue housing portion 351. The fixing portion 367 is formed to be bent from the end at the +Y side of the holding plate 366 toward the +X side. The fixing portion 367 fixes the blue polarization element holding portion 365 to the blue housing portion 351 on the side surface at the +Y side of the blue housing portion 351.

Next, the red fixing section 370 will be described. The red fixing section 370 has a red housing portion 371, a fixing portion 375, and a red polarization element holding portion 385.

The red housing portion 371 is provided at the +X side of the red fixing section 370. The red housing portion 371 opens in the X direction along the optical axis of the red light LR and is formed in a box shape. The red light source module 500R is housed inside the red housing portion 371.

A coupling portion 372 coupled to the light combining element 500 and the projection optical system 550 is provided at the +Z side of the red housing portion 371. The coupling portion 372 is fastened and fixed to a holding member (not illustrated) that holds the light combining element 500 and the projection optical system 550 together with the red light modulation element 583 and the red light exiting-side polarization element 577.

The fixing portion 375 is provided at the -X side of the red housing portion 371. The fixing portion 375 is formed in a rectangular shape having a thickness in the X direction. The fixing portion 375 has a position adjustment surface 376 and a peripheral wall portion 380. The fixing portion 375 has the same configuration as the fixing portion 320 of the green fixing section 310 and the fixing portion 355 of the blue fixing section 350.

The red polarization element holding portion 385 is provided at the +X side of the red housing portion 371. The red polarization element holding portion 385 is a member that holds the red light incident-side polarization element 573.

The red polarization element holding portion 385 has a holding plate 386 and a fixing portion 387.

The holding plate 386 is a plate in which the red light incident-side polarization element 573 is held at the center. The holding plate 386 is parallel to a plane including the Y direction and the Z direction. The holding plate 386 covers the opening at the +X side of the red housing portion 371.

The fixing portion 387 is a member that fixes the red polarization element holding portion 385 to the red housing portion 371. The fixing portion 387 is formed to be bent from the end at the +Y side of the holding plate 386 toward the -X side. The fixing portion 387 fixes the red polarization element holding portion 385 to the red housing portion 371 on the side surface at the +Y side of the red housing portion 371.

According to the configuration, the support member 300 can support the green light source module 500G, the blue light source module 500B, and the red light source module 500R with the single member.

Next, the first coupling portion 301 and the second coupling portion 305 will be described.

The first coupling portion 301 couples the ends at the +X side and the +Z side of the green housing portion 311 and the ends at the -X side and the -Z side of the blue housing portion 351. That is, the first coupling portion 301 couples the green fixing section 310 and the blue fixing section 350 at the light combining element 500 side.

The first coupling portion 301 has the same width in the Y direction as the green housing portion 311 and the blue housing portion 351, and is formed in a plate shape. The first coupling portion 301 is integrally formed with the ends at the +X side and the +Z side of the green housing portion 311 and the ends at the -X side and the -Z side of the blue housing portion 351.

The second coupling portion 305 couples the ends at the -X side and the +Z side of the green housing portion 311 and the ends at the +X side and the -Z side of the red housing portion 371. That is, the second coupling portion 305 couples the green fixing section 310 and the red fixing section 370 at the light combining element 500 side.

The second coupling portion 305 has the same width in the Y direction as the green housing portion 311 and the red housing portion 371, and is formed in a plate shape. The second coupling portion 305 is integrally formed with the ends at the -X side and the +Z side of the green housing portion 311 and the ends at the +X side and the -Z side of the red housing portion 371.

The support member 300 further has a first coupling flange portion 302 and a second coupling flange portion 306.

The first coupling flange portion 302 is a plate-shaped member extending from the first coupling portion 301 toward the +X side and the -Z side. The first coupling flange portion 302 is formed to couple the side surface at the +X side of the green housing portion 311 and the side surface at the -Z side of the blue housing portion 351. The first coupling flange portion 302 is formed integrally with the green housing portion 311, the first coupling portion 301, and the blue housing portion 351. The first coupling flange portion 302 is located at the -Y side of the center in the width of the first coupling portion 301 in the Y direction.

The second coupling flange portion 306 is a plate-shaped member extending from the second coupling portion 305 toward the -X side and the -Z side. The second coupling flange portion 306 is formed to couple the side surface at the -X side of the green housing portion 311 and the side surface at the -Z side of the red housing portion 371. The second coupling flange portion 306 is formed integrally with the green housing portion 311, the second coupling portion 305, and the red housing portion 371. The second coupling flange portion 306 is located at the -Y side of the center in the width of the second coupling portion 305 in the Y direction.

According to the configuration, the green fixing section 310, the blue fixing section 350, and the red fixing section 370 can be coupled at the light combining element 500 side located at the center of the support member 300. Therefore, the outer shape of the support member 300 can be reduced in size.

Next, the structures of the green light source module 500G, the blue light source module 500B, and the red light source module 500R will be described in more detail. The green light source module 500G, the blue light source module 500B, and the red light source module 500R have the same configuration except for the corresponding colors of light. In the present embodiment, the green light source module 500G will be described as a representative.

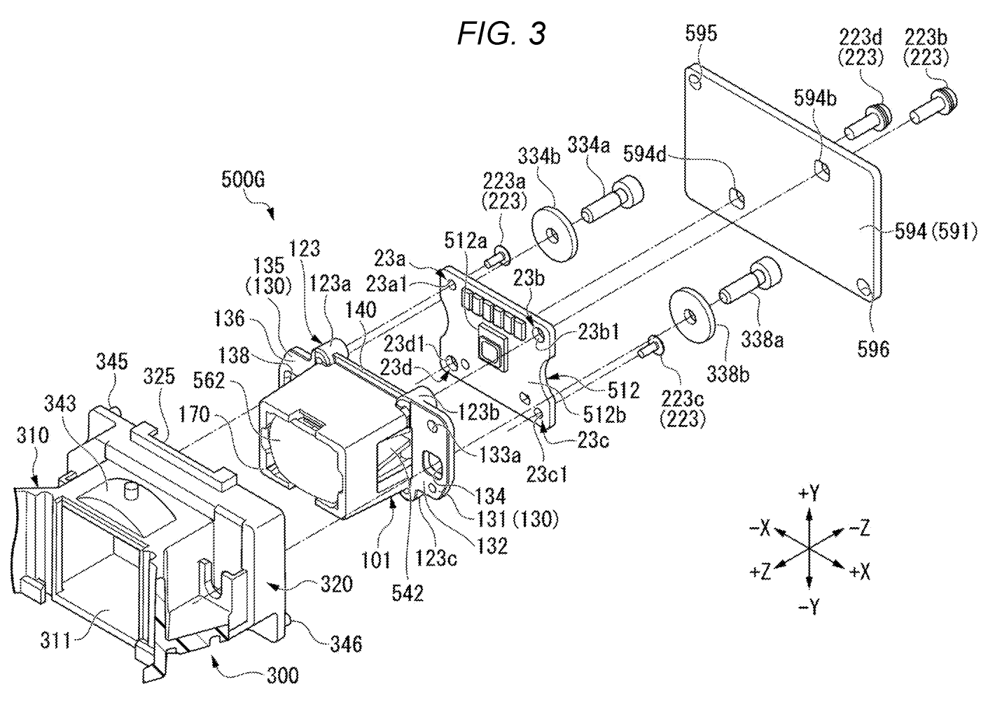

FIG. 3 is an exploded perspective view of the green light source module 500G. As illustrated in FIG. 3, the green light source module 500G has the green light source 512, the holding member 101, the green light guide element 542, and the green parallelizing element 562.

The green light source module 500G is configured by disposing the green light source 512, the holding member 101, and the green parallelizing element 562 in this order from the -Z side to the +Z side. The green light guide element 542 is held inside the holding member 101. The green light source module 500G is housed in the green housing portion 311 and fixed to the green fixing section 310.

The green substrate 512b of the green light source 512 is a rectangular plate having a longitudinal direction along the X direction and a lateral direction along the Y direction. The green substrate 512b has a thickness in the Z direction.

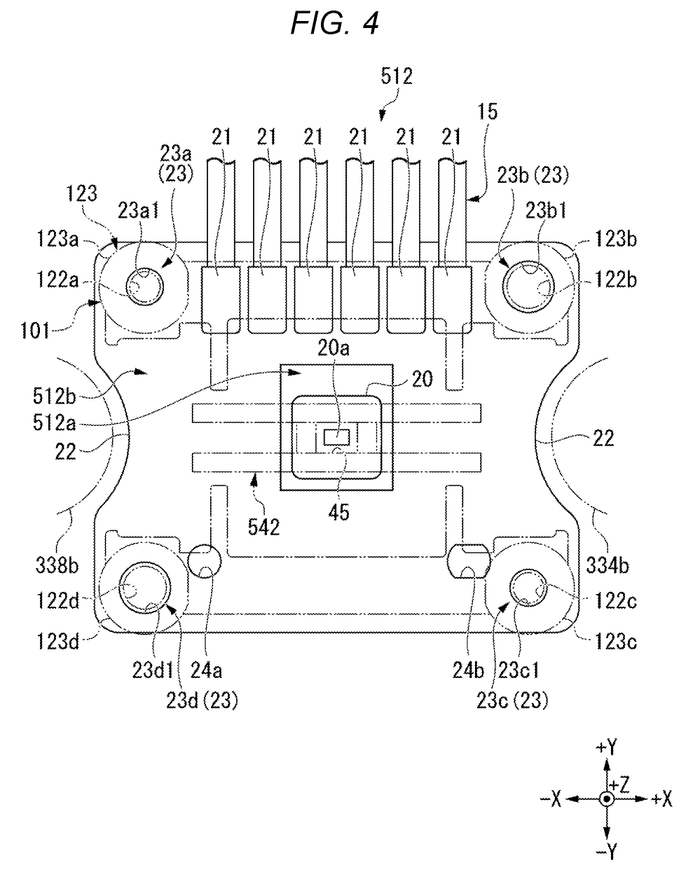

FIG. 4 is a plan view of the green light source 512. As illustrated in FIG. 4, the green substrate 512b of the green light source 512 has the green light emitting element 512a mounted thereon, and has circuit elements 21, recesses 22, a plurality of receiving portions 23, and positioning holes 24a and 24b. The green light emitting element 512a is provided at the center of a plate surface at the +Z side in the green substrate 512b. The green light emitting element 512a has a thickness in the Z direction. The green light emitting element 512a is a rectangular LED chip, and has a light emitting unit 20 in the lower part at the center. The light emitting unit 20 has a rectangular shape and has a light emitting region 20a. The light emitting region 20a emits the green light LG toward the +Z side along the Z direction.

The circuit element 21 is an electronic component including a drive circuit that drives the green light emitting element 512a. The circuit element 21 is provided at the +Y side of the plate surface at the +Z side in the green substrate 512b. A plurality of the circuit elements 21 are disposed along the longitudinal direction of the green substrate 512b at the +Y side, and, for example, six circuit elements are disposed in the case of the present embodiment. The circuit element 21 has a rectangular shape having a longitudinal direction along the Y direction and a lateral direction along the X direction. The circuit element 21 has a thickness in the Z direction. The arrangement of the circuit elements 21 on the green substrate 512b and the number of the circuit elements 21 may be appropriately changed.

Cables 15 are respectively attached to the circuit elements 21 by, for example, soldering. The cable 15 extends toward the +Y side of the green substrate 512b and is routed from the +Y side of the green fixing section 310 to the outside.

The recess 22 is formed on each side of the green substrate 512b in the lateral direction. The recesses 22 each have a semicircular shape recessed toward the center of the green substrate 512b. The recesses 22 are formed so as to avoid washers 334b and 338b, which will be described later.

The plurality of receiving portions 23 are regions provided on the surface of the green substrate 512b at the four corner sides and coming into contact with a plurality of coupling portions 123 of the holding member 101, which will be described later. The plurality of receiving portions 23 include a first receiving portion 23a, a second receiving portion 23b, a third receiving portion 23c, and a fourth receiving portion 23d.

The first receiving portion 23a and the second receiving portion 23b are provided at the +Y side of the green substrate 512b. The first receiving portion 23a and the second receiving portion 23b are arranged in order in the -X direction. The third receiving portion 23c and the fourth receiving portion 23d are provided at the -Y side of the green substrate 512b. The third receiving portion 23c and the fourth receiving portion 23d are arranged in order in the +X direction. The circuit elements 21 are disposed between the first receiving portion 23a and the second receiving portion 23b. As described above, the plurality of receiving portions 23 are disposed on the green substrate 512b so as to surround the green light emitting element 512a.

Each of the plurality of receiving portions 23 has a circular through hole penetrating in the Z direction. More specifically, the first receiving portion 23a has a first through hole 23a1. The second receiving portion 23b has a second through hole 23b1. The third receiving portion 23c has a third through hole 23c1. The fourth receiving portion 23d has a fourth through hole 23d1.

The first through hole 23a1 and the third through hole 23c1 are formed in the same hole diameter. The second through hole 23b1 and the fourth through hole 23d1 are formed in the same hole diameter. The hole diameters of the first through hole 23a1 and the third through hole 23c1 are smaller than the hole diameters of the second through hole 23b1 and the fourth through hole 23d1. The plurality of receiving portions 23 are coupled to the plurality of coupling portions 123 of the holding member 101 described later via a plurality of fixing members 223.

As illustrated in FIG. 3, the holding member 101 has a box shape with both ends in the Z direction open. The holding member 101 is fixed to the green substrate 512b. The holding member 101 has a wall portion 110, an incident end portion 140, the plurality of coupling portions 123, an attachment portion 130, and an emission end portion 170.

The wall portion 110 forms a side surface of the holding member 101 along the X direction and the Y direction.

The incident end portion 140 is provided at the -Z side facing the green substrate 512b in the wall portion 110. The incident end portion 140 forms an end of the wall portion 110 at the -Z side.

As illustrated in FIGS. 3 and 4, the plurality of coupling portions 123 are formed at four vertices at the -Z side of the wall portion 110. The plurality of coupling portions 123 have hollow cylindrical shapes as a whole and have holes penetrating in the Z direction. The plurality of coupling portions 123 have cylindrical shapes having the Z direction as an axial direction and the X direction and the Y direction as radial directions. The plurality of coupling portions 123 are provided to face the green substrate 512b. The plurality of coupling portions 123 include a first coupling portion 123a, a second coupling portion 123b, a third coupling portion 123c, and a fourth coupling portion 123d.

The first coupling portion 123a and the second coupling portion 123b are provided at the +Y side of the wall portion 110. The first coupling portion 123a and the second coupling portion 123b are arranged in order in the -X direction. The third coupling portion 123c and the fourth coupling portion 123d are provided at the -Y side of the wall portion 110. The third coupling portion 123c and the fourth coupling portion 123d are arranged in order in the +X direction. As described above, the plurality of coupling portions 123 are disposed so as to surround the green light emitting element 512a.

A first hole portion 122a is formed in the first coupling portion 123a. The first hole portion 122a is a circular hole penetrating in the Z direction. A screw thread is formed in the first hole portion 122a.

A third hole portion 122c is formed in the third coupling portion 123c. The third hole portion 122c is a circular hole penetrating in the Z direction. A screw thread is formed in the third hole portion 122c.

The first coupling portion 123a and the third coupling portion 123c have the same shape. The first hole portion 122a and the third hole portion 122c have the same shape.

A second hole portion (fixing hole) 122b is formed in the second coupling portion 123b. The second hole portion 122b is a circular hole penetrating in the Z direction. A screw thread is formed in the second hole portion 122b.

A fourth hole portion (fixing hole) 122d is formed in the fourth coupling portion 123d. The fourth hole portion 122d is a circular hole penetrating in the Z direction. A screw thread is formed in the fourth hole portion 122d.

The second coupling portion 123b and the fourth coupling portion 123d have the same shape. The second hole portion 122b and the fourth hole portion 122d have the same shape.

The first coupling portion 123a and the third coupling portion 123c have smaller outer diameters than the second coupling portion 123b and the fourth coupling portion 123d.

The first hole portion 122a and the third hole portion 122c have smaller inner diameters than the second hole portion 122b and the fourth hole portion 122d.

The plurality of coupling portions 123 and the plurality of receiving portions 23 are coupled to each other via the plurality of fixing members 223. The plurality of fixing members 223 are fasteners such as screws or bolts inserted through the through holes of the plurality of coupling portions 123 and the plurality of receiving portions 23. The plurality of fixing members 223 include a first fixing member 223a, a second fixing member 223b, a third fixing member 223c, and a fourth fixing member 223d. The first fixing member 223a and the third fixing member 223c have the same shape. The second fixing member 223b and the fourth fixing member 223d have the same shape. The first fixing member 223a and the third fixing member 223c are formed to be smaller than the second fixing member 223b and the fourth fixing member 223d as a whole.

Here, a method of fixing the green substrate 512b and the holding member 101 is described.

The first fixing member 223a is inserted through the first through hole 23a1 of the first receiving portion 23a, and inserted into the first hole portion 122a of the first coupling portion 123a. The third fixing member 223c is inserted through the third through hole 23c1 of the third receiving portion 23c, and inserted into the third hole portion 122c of the third coupling portion 123c. The second fixing member 223b is inserted through the second through hole 23b1 of the second receiving portion 23b via a green heat sink substrate 594 of the green heat sink 591 described later, and is inserted into the second hole portion 122b of the second coupling portion 123b. The fourth fixing member 223d is inserted through the fourth through hole 23d1 of the fourth receiving portion 23d via the green heat sink substrate 594 of the green heat sink 591 described later, and is inserted into the fourth hole portion 122d of the fourth coupling portion 123d. As a result, the plurality of coupling portions 123 and the plurality of receiving portions 23 come into contact with each other, and the plurality of coupling portions 123 and the plurality of receiving portions 23 are coupled to each other via the plurality of fixing members 223. Therefore, the green substrate 512b is directly fixed to holding member 101.

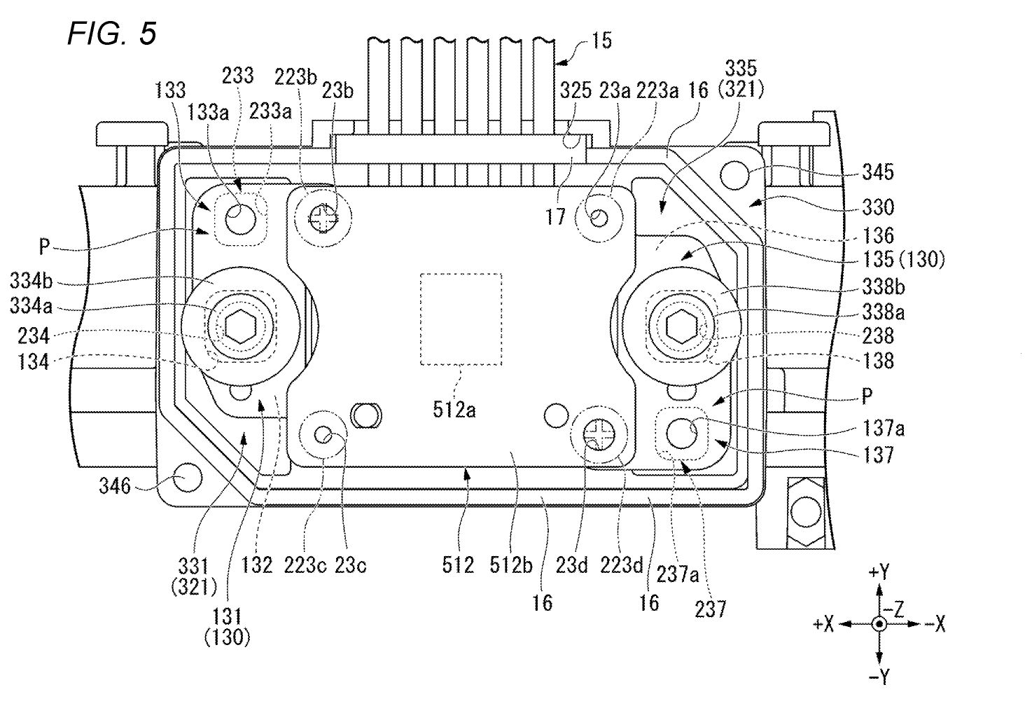

FIG. 5 is a plan view of the optical module with a plate material of a heat dissipation member removed.

As illustrated in FIGS. 4 and 5, the inner diameters of the first receiving portion 23a and the third receiving portion 23c in the green substrate 512b are formed to be larger than the inner diameters of the first hole portion 122a and the third hole portion 122c in the holding member 101. The inner diameters of the second through hole 23b1 and the fourth through hole 23d1 in the green substrate 512b are formed to be larger than the inner diameters of the second hole portion 122b and the fourth hole portion 122d in the holding member 101. Accordingly, when the fixing members 223a, 223b, 223c, and 223d are inserted, the green substrate 512b can be fixed to the holding member 101 while the positions of the green substrate in the X direction and the Y direction are adjusted.

The incident end portion 140 is provided at the -Z side facing the green substrate 512b in the wall portion 110. The incident end portion 140 forms an end of the wall portion 110 at the -Z side.

As illustrated in FIGS. 3 and 5, the attachment portion 130 is a plate-shaped member protruding along the X direction from the ends at the +Z side of the plurality of coupling portions 123. That is, the attachment portion 130 extends along the surface direction of the green substrate 512b. The attachment portion 130 is a member for attaching the unitized green light source module 500G to the support member 300.

The attachment portion 130 includes a first attachment portion 131 and a second attachment portion 135. The first attachment portion 131 extends from the ends at the +Z side of the second coupling portion 123b and the third coupling portion 123c toward the +X side. The first attachment portion 131 has a first attachment surface 132.

The first attachment surface 132 is a surface at the +Z side of the first attachment portion 131. The first attachment surface 132 comes into contact with a first adjustment surface 331 of the support member 300 described later. The first attachment surface 132 has a first opposing portion 133 and a through hole 134.

The first opposing portion 133 is provided at the +Y side of the first attachment surface 132. The first opposing portion 133 corresponds to a region of the first adjustment surface 331 in contact with a second opposing portion 233 described later.

The first opposing portion 133 has a circular hole portion 133a penetrating in the Z direction. A jig used in an assembly method described later for determining the relative position between the green light source module 500G and the support member 300 is inserted into the hole portion 133a.

In the first attachment surface 132, the through hole 134 is located linearly in the X direction in which the green light emitting element 512a is located. The through hole 134 is a rectangular hole penetrating in the Z direction. The corner portions of the through hole 134 are rounded.

The second attachment portion 135 extends from the ends at the +Z side of the first coupling portion 123a and the fourth coupling portion 123d toward the -X side. The second attachment portion 135 has a second attachment surface 136.

The second attachment surface 136 is a surface at the +Z side of the second attachment portion 135. The second attachment surface 136 comes into contact with a second adjustment surface 335 of the support member 300 described later. The second attachment surface 136 has a first opposing portion 137 and a through hole 138.

The first opposing portion 137 is provided at the -Y side of the second attachment surface 136. The first opposing portion 137 is a region in contact with a second opposing portion 237 of the second adjustment surface 335 described later.

The first opposing portion 137 has a circular hole portion 137a penetrating in the Z direction. A jig for determining the relative position between the green light source module 500G and the support member 300 is inserted into the hole portion 137a.

The through hole 138 is located linearly in the X direction in which the green light emitting element 512a is located in the second attachment portion 135. The through hole 138 is a rectangular hole penetrating in the Z direction. The corner portions of the through hole 138 are rounded.

As described above, the first opposing portion 133 provided on the first attachment surface 132 and the first opposing portion 137 provided on the second attachment surface 136 are paired, and are respectively disposed in the diagonal direction of the green substrate 512b. Similarly, the hole portion 133a provided in the first opposing portion 133 and the hole portion 137a provided in the first opposing portion 137 are paired, and are respectively disposed in the diagonal direction of the green substrate 512b.

The through hole 134 provided in the first attachment surface 132 and the through hole 138 provided in the second attachment surface 136 are paired, and are formed with the center of the green light source 512 in between.

As illustrated in FIG. 3, the emission end portion 170 forms the end of the wall portion 110 at the +Z side. The green light guide element 542 is provided inside the holding member 101. The green light guide element 542 guides the green light LG emitted from the light emitting region 20a and propagates the green light LG to the green parallelizing element 562.

The green parallelizing element 562 is provided at the emission end portion 170 side of the holding member 101. Although not illustrated, the green light modulation unit 505 may be directly attached to the emission end portion 170.

Next, the configuration of the fixing portion 320 of the green fixing section 310 in the support member 300 will be described in detail. The fixing portion 320 of the green fixing section 310, the fixing portion 355 of the blue fixing section 350, and the fixing portion 375 of the red fixing section 370 have the same configuration. In the present embodiment, the fixing portion 320 of the green fixing section 310 will be described as a representative.

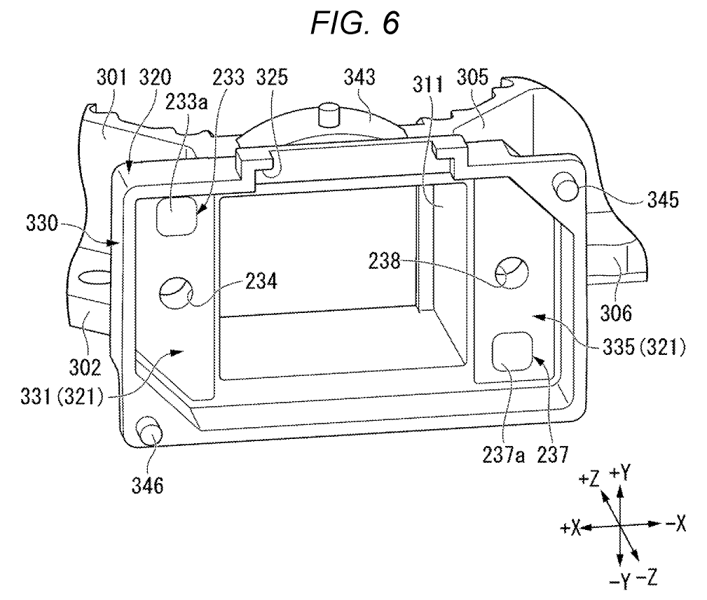

FIG. 6 is a perspective view of the support member. As illustrated in FIG. 6, the fixing portion 320 has a surface along the X direction and the Y direction coupled to the green housing portion 311 and has a thickness in the Z direction. The fixing portion 320 is formed in a substantially rectangular shape having a longitudinal direction along the X direction and a lateral direction along the Y direction. In the Z direction, the planar shape of the fixing portion 320 is larger than the planar shape of the green housing portion 311.

The fixing portion 320 has a position adjustment surface 321 and a peripheral wall portion 330. The position adjustment surface 321 is a surface for adjusting the relative position between the green light source module 500G and the support member 300. The position adjustment surface 321 is a surface facing the -Z side, which is the back side of the surface coupled to the green housing portion 311. The position adjustment surface 321 is a surface parallel to a plane including the X direction and the Y direction. The position adjustment surface 321 extends along the X direction from the opening at the -Z side of the green housing portion 311. That is, the position adjustment surface 321 extends along the surface direction of the green substrate 512b similarly to the attachment portion 130.

The position adjustment surface 321 includes a first adjustment surface 331 and a second adjustment surface 335. The first adjustment surface 331 extends from the opening at the -Z side of the green housing portion 311 toward the +X side. The first adjustment surface 331 is in contact with the first attachment surface 132.

The first adjustment surface 331 has a second opposing portion 233 and a fixing hole 234. The second opposing portion 233 is a region in contact with the first opposing portion 133 of the first attachment surface 132. The second opposing portion 233 is provided at a position corresponding to the first opposing portion 133.

The second opposing portion 233 includes a receiving portion 233a. The receiving portion 233a is a recess recessed toward the +Z side with respect to the second opposing portion 233. The receiving portion 233a is formed in a rectangular shape with rounded corners. The receiving portion 233a is formed so as to receive the tip of the jig inserted into the hole portion 133a.

The fixing hole 234 is a circular hole penetrating in the Z direction. The fixing hole 234 is formed at a position overlapping the through hole 134 when viewed from the Z direction. The fixing hole 234 is formed to be smaller than the through hole 134. Specifically, the fixing hole 234 is located inside the through hole 134 when viewed from the Z direction.

When the relative position between the green light source module 500G and the support member 300 is determined, the first opposing portion 133 and the second opposing portion 233 at least partially overlap each other when viewed in the Z direction along the optical axis direction of the green light LG. Specifically, the hole portion 133a of the first opposing portion 133 and the receiving portion 233a of the second opposing portion 233 overlap each other.

The second adjustment surface 335 extends from the opening at the -Z side of the green housing portion 311 toward the -X side. The second adjustment surface 335 is in contact with the second attachment surface 136.

The second adjustment surface 335 has a second opposing portion 237 and a fixing hole 238. The second opposing portion 237 is a region in contact with the first opposing portion 137 of the second attachment surface 136. The second opposing portion 237 is provided at a position corresponding to the first opposing portion 137.

The second opposing portion 237 has a receiving portion 237a. The receiving portion 237a is a recess recessed toward the +Z side with respect to the second opposing portion 237. The receiving portion 237a is formed in a rectangular shape with rounded corners. The receiving portion 237a is formed so as to receive the tip of the jig inserted into the hole portion 137a.

The fixing hole 238 is a circular hole penetrating in the Z direction. The fixing hole 238 is formed at a position overlapping the through hole 138 when viewed from the Z direction. The fixing hole 238 is formed to be smaller than the through hole 138. Specifically, the fixing hole 238 is located inside the through hole 138 when viewed from the Z direction.

As described above, the second opposing portion 233 provided on the first adjustment surface 331 and the second opposing portion 237 provided on the second adjustment surface 335 are paired, and are disposed in the diagonal direction of the green substrate 512b. Similarly, the receiving portion 233a provided in the second opposing portion 233 and the receiving portion 237a provided in the second opposing portion 237 are paired, and are disposed in the diagonal direction of the green substrate 512b.

In the present embodiment, the first opposing portions 133 and 137 and the second opposing portions 233 and 237 correspond to an example of a "positioning portion P" of the present disclosure. That is, the positioning portion P includes a configuration used for, not limited to relative positioning between the green light source module 500G and the support member 300 and indication of a portion in which the module and the member are fixed to each other, but determination of the relative position between the module and the member including the receiving portions 233a and 237a and the hole portions 133a and 137a as the holes and recesses of the present embodiment.

According to the configuration, the holes and recesses are disposed in the diagonal direction, and thus it is possible to suppress a three-dimensional deviation of the green light source module 500G in the XYZ directions with respect to the support member 300.

The fixing hole 234 provided in the first adjustment surface 331 and the fixing hole 238 provided in the second adjustment surface 335 are paired, and are formed with the center of the green light source 512 in between.

According to the configuration, the green light source module 500G can be fixed to the support member 300 after the green light source module 500G is positioned with respect to the support member 300. Since the through holes 134 and 138 and the fixing holes 234 and 238 are formed with the center of the green light source 512 in between, the green light source module 500G can be stably fixed to the support member 300. Therefore, the positioning accuracy is improved.

When the relative position between the green light source module 500G and the support member 300 is determined, the first opposing portion 137 and the second opposing portion 237 at least partially overlap each other when viewed in the Z direction along the optical axis direction of the green light LG. Specifically, the hole portion 137a of the first opposing portion 137 and the receiving portion 237a of the second opposing portion 237 overlap each other. The relative position of the green light source module 500G and the support member 300 is determined by an alignment step using a jig described later. The alignment step will be described later.

According to the configuration, the first opposing portion 133 and second opposing portion 233 and the first opposing portion 137 and second opposing portion 237 overlap each other when viewed in the Z direction, thereby functioning as marks for positioning the green light source module 500G and the support member 300. Accordingly, the green light source module 500G can be easily positioned in the X direction and the Y direction with respect to the support member 300. Thus, the position of the support member 300 can be adjusted with high accuracy with respect to the green light source module 500G. Therefore, since the optical axis of the green light source 512 and the optical axis of the support member 300 can be aligned with each other, the light use efficiency can be improved.

The attachment portion 130 and the position adjustment surface 321 are coupled to each other via bolts 334a and 338a and washers 334b and 338b as first fixing members. The bolt 334a and the bolt 338a have the same shape. The washer 334b and the washer 338b have the same shape.

The outer shapes of the threaded portions of the bolts 334a and 338a are formed to be smaller than the inner diameters of the through holes 134 and 138. That is, the inner diameters of the through holes 134 and 138 are larger than the fixing holes 234 and 238 of the support member 300 described later, to which the bolts 334a and 338a are screwed. Therefore, the through holes 134 and 138 are in the so-called loose hole states with respect to the fixing holes 234 and 238. The outer shapes of the washers 334b and 338b are formed to be larger than the inner diameters of the through holes 134 and 138.

Here, a method of fixing the support member 300 and the green light source module 500G is described. An assembly method for determining the relative position between the green light source module 500G and the support member 300 will be described later.

The bolt 334a is inserted through the through hole 134 of the first attachment surface 132 via the washer 334b and screwed into the fixing hole 234 of the first adjustment surface 331.

The bolt 338a is inserted through the through hole 138 of the second attachment surface 136 via the washer 338b and screwed into the fixing hole 238 of the second adjustment surface 335.

As illustrated in FIG. 2, the bolts 334a and 338a protrude from the surface at the +Z side of the fixing portion 320. The bolt 334a is fixed to the fixing portion 320 by a washer 334c. The bolt 338a is fixed to the fixing portion 320 by a washer 338c.

Accordingly, the first attachment surface 132 is in contact with the first adjustment surface 331. The second attachment surface 136 is in contact with the second adjustment surface 335. The through holes 134 and 138 and the fixing holes 234 and 238 are coupled to each other via the bolts 334a and 338a and the washers 334b and 338b. Thus, the green light source module 500G is fixed to the support member 300.

The peripheral wall portion 330 is provided at the -Z side, which is the emission side of the green light LG, with respect to the position adjustment surface 321. The peripheral wall portion 330 protrudes from the peripheral edge portion in the position adjustment surface 321 toward the incident side of the green light LG along the optical axis of the green light LG. That is, the peripheral wall portion 330 protrudes from the peripheral edge portion in the position adjustment surface 321 toward the -Z side along the Z direction. The peripheral wall portion 330 is not necessarily formed over the entire periphery of the peripheral edge portion of the position adjustment surface 321.

In the peripheral wall portion 330, a step portion 325 is formed at the center of the peripheral edge at the +Y side. The step portion 325 is a step recessed toward the +Z side with respect to the -Z side surface of the peripheral wall portion 330. The step portion 325 functions as a gap in which the cable 15 extending from the green substrate 512b toward the +Y side is routed to the outside of the green fixing section 310.

Positioning pins 345 and 346 are formed on the peripheral wall portion 330. The positioning pins 345 and 346 function as guides for positioning when the green heat sink substrate 594 described later is fixed to the green fixing section 310. The positioning pins 345 and 346 protrude from the peripheral wall portion 330 toward the -Z side.

The positioning pin 345 is provided in the end at the -X side and the +Y side of the peripheral wall portion 330. The positioning pin 346 is provided in the end at the +X side and the -Y side of the peripheral wall portion 330. The positioning pin 345 and the positioning pin 346 have the same diameter. The positioning pins 345 and 346 are inserted into pin holes 595 and 596 described later.

As illustrated in FIG. 5, sealing materials 16 are provided at the -Z side of the peripheral wall portion 330. The sealing material 16 is formed along the shape of the ends of the peripheral wall portion 330 at the -Z side. The sealing material 16 prevents dust, dirt, and the like from entering the green fixing section 310 from between the green heat sink substrate 594 described later and the peripheral wall portion 330.

A cushion 17 is provided between the peripheral edge portion of the sealing material 16 at the +Y side and the step portion 325. The cushion 17 is provided to fill a gap between the step portion 325 and the cable 15 routed from the +Y side of the green fixing section 310 to the outside. The cable 15 can prevent dust, dirt, and the like from entering the inside of the green fixing section 310 through the gap formed by the step portion 325.

According to the configuration, the peripheral wall portion 330 can protect the position adjustment surface 321 and the attachment portion 130 for positioning from an impact from the outside. In addition, it is possible to prevent dust, dirt, and the like from entering the inside of the green fixing section 310 and the green light source module 500G.

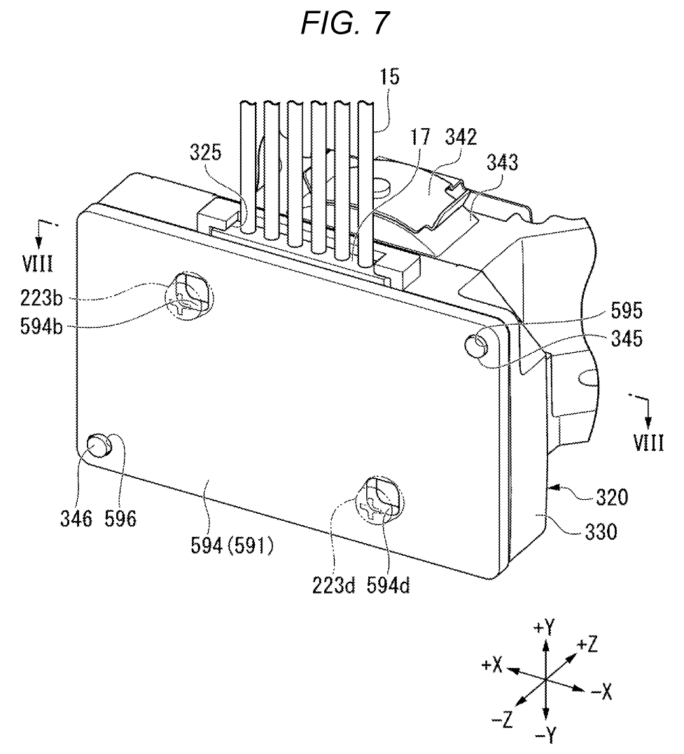

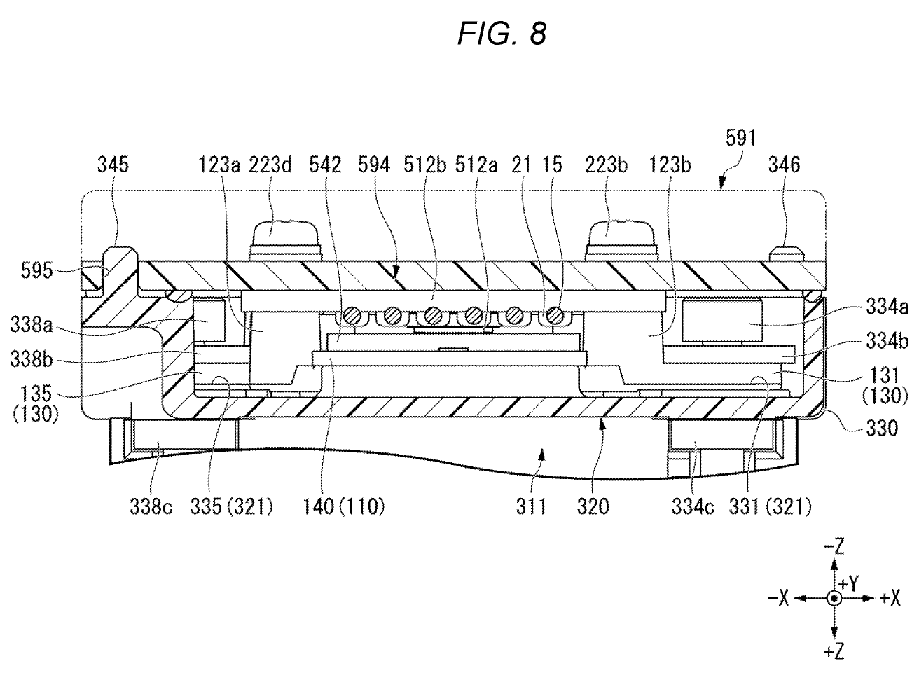

FIG. 7 is a perspective view showing the heat dissipation member and the support member. FIG. 8 is a cross-sectional view taken along line VIII in FIG. 7. As illustrated in FIGS. 3, 7, and 8, the green heat sink 591 is a member that dissipates heat of the green light source 512 of the green light source module 500G. The green heat sink 591 is attached to the -Z side surface of the green substrate 512b. The green substrate 512b is provided with the green light emitting element 512a on the surface at the +Z side, and the surface at the -Z side is a surface opposite to the surface at the +Z side.

The green heat sink 591 has the green heat sink substrate 594. The green heat sink substrate 594 is a member for attaching the green heat sink 591 to the green light source module 500G. The green heat sink substrate 594 has through holes (first through holes) 594b and 594d and pin holes 595 and 596.

The through holes 594b and 594d are rectangular holes penetrating in the Z direction. Corner portions of the through holes 594b and 594d are rounded.

The through hole 594b is formed at a position overlapping the second through hole 23b1 of the green substrate 512b and the second hole portion 122b of the holding member 101 when viewed from the Z direction. The through hole 594d is formed at a position overlapping the fourth through hole 23d1 of the green substrate 512b and the fourth hole portion 122d of the holding member 101 when viewed from the Z direction.

The second fixing member (second fixing member) 223b and the fourth fixing member (second fixing member) 223d are inserted through the through holes 594b and 594d. The second fixing member 223b is inserted through the through hole 594b of the green heat sink substrate 594 and the second through hole 23b1 of the second receiving portion 23b, and is screwed into the second hole portion 122b of the second coupling portion 123b. The fourth fixing member 223d is inserted through the through hole 594d of the green heat sink substrate 594 and the fourth through hole 23d1 of the fourth receiving portion 23d, and is screwed into the fourth hole portion 122d of the fourth coupling portion 123d.

The hole diameters of the through holes 594b and 594d are larger than the hole diameters of the second through hole 23b1 and the fourth through hole 23d1 of the green substrate 512b.

The outer shapes of the threaded portions of the second fixing member 223b and the fourth fixing member 223d are smaller than the inner diameters of the through holes 594b and 594d. That is, the inner diameters of the through holes 594b and 594d are formed to be larger than the second hole portion 122b and the fourth hole portion 122d of the holding member 101 into which the second fixing member 223b and the fourth fixing member 223d are screwed. Therefore, the through holes 594b and 594d are in the so-called loose hole states with respect to the second hole portion 122b and the fourth hole portion 122d.

The pin holes 595 and 596 are formed in the corners of the green heat sink substrate 594. The pin holes 595 and 596 are holes penetrating in the Z direction. The pin hole 595 is formed in the corner at the -X side and the +Y side of the green heat sink substrate 594. The pin hole 596 is formed in the corner at the +X side and the -Y side of the green heat sink substrate 594. The positioning pins 345 and 346 are inserted into the pin holes 595 and 596, respectively.

As described above, the green heat sink 591 is fastened and fixed to the holding member 101 by the second fixing member 223b and the fourth fixing member 223d with the green substrate 512b sandwiched between the holding member 101 and itself.

According to the configuration, the green heat sink 591 can be disposed in contact with the back surface of the green substrate 512b provided with the green light emitting element 512a that generates heat. Therefore, the heat generated from the green light emitting element 512a can be efficiently dissipated.

The green heat sink 591 is directly fixed to the holding member 101 with the green substrate 512b in between. Therefore, the number of components for attaching the green heat sink 591 can be reduced.

As described above, the optical module M of the present embodiment includes the green light source module 500G having the green light source 512 that emits the green light LG, the support member 300 that supports the green light source module 500G, the positioning portion P that positions the green light source module 500G with respect to the support member 300, and the green light modulation unit 505 that modulates the green light LG incident from the green light source module 500G. The green light source module 500G has the green light source 512 including the green light emitting element 512a that emits the green light LG and the green substrate 512b on which the green light emitting element 512a is mounted, and the holding member 101 fixed to the green substrate 512b. The holding member 101 has the attachment portion 130 that extends along the surface direction of the green substrate 512b and attaches the green light source module 500G to the support member 300. The attachment portion 130 has attachment surfaces 132 and 136 in contact with the support member 300, and the support member 300 has the first adjustment surface 331 and the second adjustment surface 335 in contact with the attachment surfaces 132 and 136 for adjusting the relative position between the green light source module 500G and the support member 300. The positioning portion P includes the first opposing portions 133 and 137 provided on the attachment surfaces 132 and 136 and the second opposing portions 233 and 237 provided at the positions corresponding to the first opposing portions 133 and 137 of the first adjustment surface 331 and the second adjustment surface 335. When the relative position between the green light source module 500G and the support member 300 is determined, the first opposing portions 133 and 137 and the second opposing portions 233 and 237 at least partially overlap each other when viewed from the direction along the optical axis direction of the green light LG.

According to the optical module of the present embodiment, the first opposing portion 133 and second opposing portion 233 and the first opposing portion 137 and second opposing portion 237 overlap each other when viewed in the Z direction, thereby functioning as marks for positioning the green light source module 500G and the support member 300. Accordingly, the green light source module 500G can be easily positioned in the X direction and the Y direction with respect to the support member 300. Thus, the position of the support member 300 can be adjusted with high accuracy with respect to the green light source module 500G. Therefore, since the optical axis of the green light source 512 and the optical axis of the support member 300 can be aligned with each other, the light use efficiency can be improved.

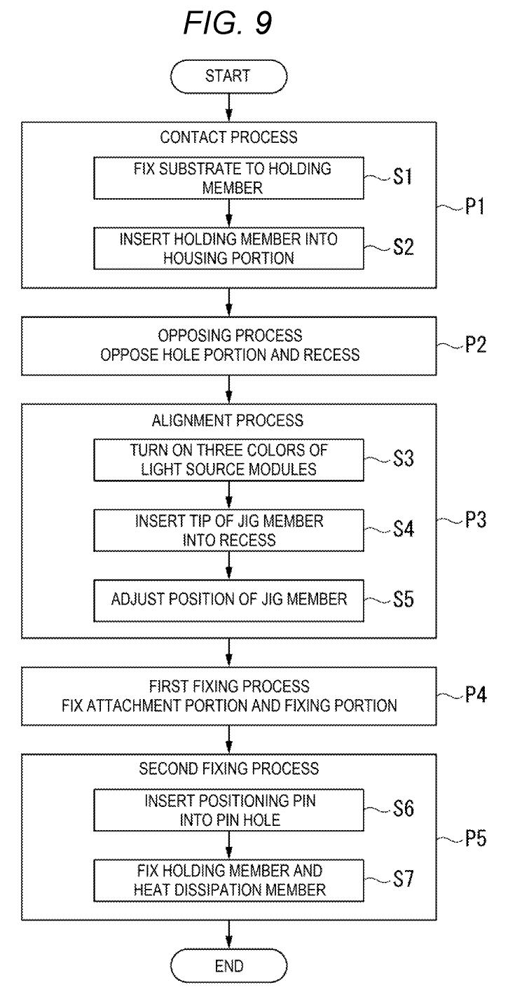

Next, the assembly method for the optical module M of the present embodiment will be described. The green light source module 500G, the blue light source module 500B, and the red light source module 500R have the same configuration. Therefore, in the following description, as the assembly method for the optical module M, a method of attaching the green light source module 500G having the green light source 512 to the support member 300 will be described as an example. FIG. 9 is a flowchart showing the assembly method for the optical module.

As illustrated in FIG. 9, the present assembly method includes five processes of a first process P1 to a fifth process P5.

The first process P1 is a contact process of bringing the attachment portion 130 of the green light source module 500G into contact with the fixing portion 320 of the support member 300. The first process P1 includes a first step S1 of fixing the green substrate 512b of the green light source 512 to the holding member 101, and a second step S2 of inserting the holding member 101 into the green housing portion 311. In the first process P1, the first step S1 is performed first, and then the second step S2 is performed.

In the first step S1, the green substrate 512b of the green light source 512 is fixed to the holding member 101.

Hereinafter, the first step S1 will be specifically described.

First, the -Z side of the holding member 101 and the +Z side surface of the green substrate 512b are disposed to face each other. Then, the holding member 101 and the green substrate 512b are positioned. When the positioning is completed, as illustrated in FIG. 3, the first fixing member 223a is inserted through the first through hole 23a1 of the first receiving portion 23a, and is inserted into the first hole portion 122a of the first coupling portion 123a. The third fixing member 223c is inserted through the third through hole 23c1 of the third receiving portion 23c, and inserted into the third hole portion 122c of the third coupling portion 123c. When the holding member 101 and the green substrate 512b are fastened and fixed, the positions of the holding member 101 and the green substrate 512b in the Z direction are determined. Thereby, the holding member 101 and the green substrate 512b are directly coupled. Similarly to the green substrate 512b, the blue substrate 511b and the red substrate 513b are directly coupled to the holding member.

In addition, as illustrated in FIG. 4, the hole diameters of the first through hole 23a1 and the third through hole 23c1 are formed to be smaller than the hole diameters of the second through hole 23b1 and the fourth through hole 23d1. The first fixing member 223a and the third fixing member 223c are formed to be smaller than the second fixing member 223b and the fourth fixing member 223d as a whole. Therefore, it is possible to prevent the holding member 101 and the green substrate 512b from being fixed to each other at wrong positions among the four positions of the plurality of coupling portions 123 and the plurality of receiving portions 23.

In the second step S2, the holding member 101 is inserted into the green housing portion 311.

Hereinafter, the second step S2 will be specifically described.

First, the +Z side of the green light source module 500G and the -Z side of the fixing portion 320 are disposed to face each other. Similarly, the +X side of the blue light source module 500B and the -X side of the fixing portion 355 are disposed to face each other. The -X side of the red light source module 500R and the +X side of the fixing portion 375 are disposed to face each other.

Then, as illustrated in FIGS. 2 and 3, the green light source module 500G is inserted into the green housing portion 311. Accordingly, the attachment portion 130 of the green light source module 500G and the fixing portion 320 of the support member 300 come into contact with each other. That is, the first attachment surface 132 and first adjustment surface 331 and the second attachment surface 136 and second adjustment surface 335 come into contact with each other, respectively. Here, the end at the -Z side of the peripheral wall portion 330 and the -Z side surface of the green substrate 512b are located on the same plane in the plane including the X direction and the Y direction. According to the second step S2, since the holding member 101 can be housed in the green housing portion 311, the attachment portion 130 and the fixing portion 320 can be stably brought into contact with each other.

The blue light source module 500B and the red light source module 500R are inserted into the blue housing portion 351 and the red housing portion 371, respectively, in the same procedure as that for the green light source module 500G.

In this way, the first process P1 is completed.

The second process P2 is an opposing process of opposing the hole portions 133a and 137a of the attachment portion 130 and the receiving portions 233a and 237a of the fixing portion 320 each other.

Hereinafter, the second process P2 will be specifically described.

First, the green light source module 500G is moved to a position where the first opposing portion 133 and the second opposing portion 233, and the first opposing portion 137 and the second opposing portion 237 are in contact with each other in a plane including the X direction and the Y direction.

As illustrated in FIG. 5, the hole portion 133a of the first opposing portion 133 and the receiving portion 233a of the second opposing portion 233 are opposed to each other in the Z direction. Similarly, the hole portion 137a of the first opposing portion 137 and the receiving portion 237a of the second opposing portion 237 are opposed to each other in the Z direction.

In this way, the second process P2 is completed.

The third process P3 is an alignment process of aligning the hole portions 133a and 137a with the receiving portions 233a and 237a in the optical axis direction of the green light source 512.

The third process P3 includes a third step S3 of turning on the green light source module 500G, the blue light source module 500B, and the red light source module 500R, a fourth step S4 of inserting the tips of the jig inserted into the hole portions 133a and 137a into the receiving portions 233a and 237a, and a fifth step S5 of adjusting the position of the jig based on the lights emitted from the light source modules of the respective colors. In the third process P3, first, the third step S3 and the fourth step S4 are performed, and then the fifth step S5 is performed.

In the third step S3, the green light source module 500G, the blue light source module 500B, and the red light source module 500R are positioned with respect to the support member 300.

First, the green light source module 500G, the blue light source module 500B, and the red light source module 500R are turned on. When the three light source modules are turned on, a white image is projected on the screen SCR.

In the fourth step S4, the tips of the jig inserted into the hole portions 133a and 137a are inserted into the receiving portions 233a and 237a.

Then, in the green light source module 500G, the jig is inserted into the hole portion 133a and the hole portion 137a. The receiving portion 233a and the receiving portion 237a receive the tips of the jig, so that the jig can position the green light source module 500G and the support member 300. According to the fourth step S4, the jig can be smoothly inserted.

The order of the third step S3 and the fourth step S4 may be reversed.

In the fifth step S5, the position of the jig is adjusted based on the lights emitted from the respective color light sources.

Specifically, the jig moves the green light source module 500G, the blue light source module 500B, and the red light source module 500R with respect to the support member 300 so that the white light projected on the screen SCR has a desired color balance. That is, the green light source module 500G is positioned in the X direction and the Y direction with respect to the support member 300, and the blue light source module 500B and the red light source module 500R are positioned in the Y direction and the Z direction with respect to the support member 300.

According to the fifth step S5, since the positions of the green light source module 500G, the blue light source module 500B, and the red light source module 500R can be adjusted with high accuracy with respect to the support member 300 by the jig, the accuracy of positioning is improved. Therefore, since the optical axes of the respective color light sources 511, 512, and 513 can be aligned with the optical axis of the support member 300, the light use efficiency of the optical module M can be improved.

In this way, the third process P3 is completed.

The fourth process P4 is a first fixing process of fixing the attachment portion 130 and the fixing portion 320. In the fourth process P4, the green light source module 500G, the blue light source module 500B, and the red light source module 500R are fixed to the support member 300.

Hereinafter, the fourth process P4 will be specifically described.

As illustrated in FIGS. 3 and 4, the green light source module 500G is fixed to the support member 300 by the bolts (second screw members) 334a and 338a. The bolt 334a is inserted through the through hole 134 of the first attachment surface 132 via the washer 334b, and is inserted into the fixing hole 234 of the first adjustment surface 331. The bolt 338a is inserted through the through hole 138 of the second attachment surface 136 via the washer 338b, and is inserted into the fixing hole 238 of the second adjustment surface 335.

The outer shapes of the threaded portions of the bolts 334a and 338a are formed to be smaller than the inner diameters of the through holes 134 and 138. The outer shapes of the washers 334b and 338b are formed to be larger than the inner diameters of the through holes 134 and 138. Furthermore, the through holes 134 and 138 are formed to be larger than the fixing holes 234 and 238. Therefore, even when the centers of the through holes 134 and 138 and the centers of the fixing holes 234 and 238 are not coaxial, the bolts (second screw members) 334a and 338a can be inserted by positioning. Therefore, the attachment portion 130 and the fixing portion 320 can be fixed.

The blue light source module 500B and the red light source module 500R are fixed to the support member 300 in the same procedure as that for the green light source module 500G.

In this way, the fourth process P4 is completed.

The fifth process P5 is a second fixing process of fixing the holding member 101 and the green heat sink 591 via the second fixing member 223b and the fourth fixing member 223d with the green light source 512 between the holding member 101 and the green heat sink 591.

In the fifth process P5, the green heat sink 591, the blue heat sink 592, and the red heat sink 593 are attached to the green light source module 500G, the blue light source module 500B, and the red light source module 500R, respectively. Since the green heat sink 591, the blue heat sink 592, and the red heat sink 593 have the same configuration, the step of attaching the green heat sink 591 will be specifically described here.

The fifth process P5 includes a sixth step S6 of inserting the positioning pins 345 and 346 extending from the fixing portion 320 into the pin holes 595 and 596 provided in the green heat sink substrate 594, and a seventh step S7 of fixing the holding member 101 and the green heat sink 591 via the second fixing member 223b and the fourth fixing member 223d. In the fifth process P5, the sixth step S6 is performed first, and then the seventh step S7 is performed.

In the sixth step S6, the positioning pins 345 and 346 extending from the fixing portion 320 are inserted into the pin holes 595 and 596 provided in the green heat sink substrate 594.

Hereinafter, the sixth step S6 will be specifically described.

First, the +Z side surface of the green heat sink substrate 594 of the green heat sink 591 and the -Z side surface of the green substrate 512b are disposed to face each other. Subsequently, as illustrated in FIGS. 7 and 8, the positioning pin 345 is inserted into the pin hole 595, and the positioning pin 346 is inserted into the pin hole 596. When the positioning pins 345 and 346 are inserted into the pin holes 595 and 596, the positions of the green heat sink 591 and the support member 300 in the X direction and the Y direction are determined. According to the sixth step S6, by inserting the positioning pins 345 and 346 into the pin holes 595 and 596, it is possible to smoothly guide the green heat sink substrate 594 when attaching to the holding member 101. Further, by fitting the positioning pins 345 and 346 into the pin holes 595 and 596, it is possible to prevent dust, dirt, or the like from entering the green light source module 500G attached to the support member 300.

In the seventh step S7, the holding member 101 and the green heat sink 591 are fixed via the second fixing member 223b and the fourth fixing member 223d.

Hereinafter, the seventh step S7 will be specifically described.

When the positioning is completed in the sixth step S6, as illustrated in FIGS. 7 and 8, the second fixing member 223b is inserted through the through hole 594b of the green heat sink substrate 594 and the second through hole 23b1 of the second receiving portion 23b, and is inserted into the second hole portion 122b of the second coupling portion 123b. The fourth fixing member 223d is inserted through the through hole 594d of the green heat sink substrate 594 and the fourth through hole 23d1 of the fourth receiving portion 23d, and is inserted into the fourth hole portion 122d of the fourth coupling portion 123d.

In this way, the fifth process P5 is completed.

As illustrated in FIG. 3, the outer shapes of the threaded portions of the second fixing member 223b and the fourth fixing member 223d are formed to be smaller than the inner diameters of the through holes 594b and 594d. Therefore, even when the position of the green heat sink substrate 594 is moved, the second fixing member 223b and the fourth fixing member 223d can be inserted into the through holes 594b and 594d by positioning.

In addition, as illustrated in FIG. 3, the hole diameters of the through holes 594b and 594d of the green heat sink substrate 594 are formed to be larger than the hole diameters of the second through hole 23b1 and the fourth through hole 23d1 of the green substrate 512b. The hole diameters of the second through hole 23b1 and the fourth through hole 23d1 of green substrate 512b are formed to be larger than the inner diameters of the second hole portion 122b and the fourth hole portion 122d in the holding member 101. The green heat sink substrate 594 is fastened and fixed to the second hole portion 122b and the fourth hole portion 122d in the holding member 101.

Therefore, even when the centers of the through holes 594b and 594d, the centers of the second through hole 23b1 and the fourth through hole 23d1, and the centers of the second hole portion 122b and the fourth hole portion 122d are not coaxial, the second fixing member 223b and the fourth fixing member 223d can be inserted by positioning.

The second fixing member 223b and the fourth fixing member 223d are formed to be larger than the first fixing member 223a and the third fixing member 223c as a whole. Therefore, it is possible to stably fix the green heat sink 591 having the heavier weight.

As illustrated in FIG. 8, when the green heat sink substrate 594 is fastened and fixed to the holding member 101, the +Z side surface of the green heat sink substrate 594 and the -Z side surface of the green substrate 512b come into contact with each other. Therefore, the heat generated from the green light emitting element 512a of the green substrate 512b can be efficiently dissipated.

In this way, the green heat sink 591 is positioned with respect to the support member 300. In a case where the green heat sink 591 is positioned with respect to the green light source module 500G, when the green light source module 500G is moved by the positioning, the green heat sink 591 also moves. Since the green heat sink 591 is a large component, when moving, the green heat sink 591 may not fit in the housing of the projector 501. In contrast, in the present disclosure, the green heat sink 591 is positioned with respect to the support member 300 and is in contact with the green substrate 512b. Therefore, the green heat sink 591 can efficiently dissipate the heat generated from the green light emitting element 512a, and the green light source module 500G can be easily positioned. Thus, the assembly is easier.

The blue heat sink 592 and the red heat sink 593 are fixed in the same procedure as that of the green heat sink 591. Although the green heat sink 591, the blue heat sink 592, and the red heat sink 593 are described as separate components, the green heat sink 591, the blue heat sink 592, and the red heat sink 593 may be integrated.

The optical module M can be assembled by performing the first process P1 to the fifth process P5 described above. According to the first process P1 to the fifth process P5, it is possible to easily assemble the optical module while accurately aligning the optical axis directions of the green light source 512 of the green light source module 500G and the support member 300. Therefore, since the optical axis of the green light source 512 and the optical axis of the support member 300 can be aligned, the light use efficiency of the optical module M can be improved.

As described above, the projector 501 of the present embodiment includes the optical module M described above.

Since the projector 501 of the present embodiment includes the optical module M, it is possible to provide a projector capable of improving light use efficiency.

The green light source module 500G, the blue light source module 500B, and the red light source module 500R are desirably fixed to the optical module M by the above-described assembly method, but may be applied to a light source module of at least one color.

Some preferable embodiments of the present disclosure have been described hereinabove in detail. However, the present disclosure is not limited to such specific embodiments, and various modifications and changes can be made thereto within the scope of the present disclosure set forth in the appended claims.

The present disclosure will be summarized below as appendices.

### Appendix 1

An optical module includes a first light source module having a first light source that emits a first light, a support member that supports the first light source module, a positioning portion that positions the first light source module with respect to the support member, and a first light modulation unit that modulates the first light incident from the first light source module, wherein the first light source module has a first light source including a first light emitting element that emits the first light, and a first substrate on which the first light emitting element is mounted, and a holding member fixed to the first substrate, the holding member has an attachment portion that extends along a surface direction of the first substrate and attaches the first light source module to the support member, the attachment portion has an attachment surface in contact with the support member, the support member has a position adjustment surface in contact with the attachment surface for adjusting a relative position between the first light source module and the support member, the positioning portion includes a first opposing portion provided on the attachment surface and a second opposing portion provided at a position corresponding to the first opposing portion on the position adjustment surface, and when the relative position between the first light source module and the support member is determined, the first opposing portion and the second opposing portion at least partially overlap each other when viewed in a direction along an optical axis direction of the first light.

According to the light source module having the configuration, the first opposing portion and second opposing portion and the first opposing portion and second opposing portion overlap each other when viewed from the direction along the optical axis direction of the first light, thereby functioning as marks for positioning the first light source module and the support member. Accordingly, the first light source module can be easily positioned with respect to the support member in the direction orthogonal to the optical axis direction of the first light. Thus, the position of the support member can be adjusted with high accuracy with respect to the first light source module. Therefore, since the optical axis of the first light source and the optical axis of the support member can be aligned with each other, the light use efficiency can be improved.

### Appendix 2

The optical module according to Appendix 1, further includes a second light source module having a second light source including a second light emitting element that emits a second light in a wavelength band different from that of the first light, and a second substrate on which the second light emitting element is mounted, a third light source module having a third light source including a third light emitting element that emits a third light in a wavelength band different from those of the first light and the second light, and a third substrate on which the third light emitting element is mounted, a second light modulation unit that modulates the second light incident from the second light source, and a third light modulation unit that modulates the third light incident from the third light source, wherein the support member further supports the second light source module and the third light source module, the first light source module supported by the support member is disposed to face the first light modulation unit, the second light source module supported by the support member is disposed to face the second light modulation unit, and the third light source module supported by the support member is disposed to face the third light modulation unit.

According to the configuration, the support member can support the first light source module, the second light source module, and the third light source module with the single member.

### Appendix 3

The optical module according to Appendix 2, further includes a light combining element that combines the light emitted from the first light modulation unit, the light emitted from the second light modulation unit, and the light emitted from the third light modulation unit, wherein the support member has a first fixing section that fixes the first light source module, a second fixing section that fixes the second light source module, a third fixing section that fixes the third light source module, a first coupling portion that couples the first fixing section and the second fixing section at the light combining element side, and a second coupling portion that couples the first fixing section and the third fixing section at the light combining element side, and the first fixing section, the second fixing section, and the third fixing section are disposed to surround the light combining element.

According to the configuration, the first fixing section, the second fixing section, and the third fixing section can be coupled at the light combining element side located at the center of the support member. Therefore, the outer shape of the support member can be reduced in size.

### Appendix 4

In the optical module according to any one of Appendices 1 to 3, the support member has a first fixing section that fixes the first light source module, the first fixing section includes a housing portion that opens along the optical axis of the first light and houses at least a part of the first light source module, and the housing portion is located at an emission side of the first light with respect to the position adjustment surface and has a peripheral wall portion protruding toward a light incident side in a direction along the optical axis of the first light in at least a part of a peripheral edge portion in the position adjustment surface.

According to the configuration, the peripheral wall portion can protect the position adjustment surface and the attachment surface for positioning from an impact from the outside. In addition, it is possible to prevent dust, dirt, or the like from entering the first fixing section and the first light source module.

### Appendix 5

In the optical module according to any one of Appendices 1 to 4, the first opposing portion and the second opposing portion are respectively disposed in a diagonal direction of the first substrate, the first opposing portion is provided with a pair of hole portions for inserting a jig for determining the relative position between the first light source module and the support member, and the second opposing portion is provided with a pair of receiving portions for receiving the jig at positions corresponding to the pair of hole portions.

According to the configuration, the opposing portions are disposed in the diagonal direction, and thus it is possible to suppress a deviation in a three-dimensional direction of the first light source module with respect to the support member.

### Appendix 6

In the optical module according to any one of Appendices 1 to 5, the attachment portion has a pair of through holes formed in the attachment surface with a center of the first light source in between, the position adjustment surface has a pair of fixing holes to which a first fixing member for fixing the holding member is fixed formed at positions corresponding to the pair of through holes, and the first light source module is fixed to the support member by respectively coupling the pair of through holes and the pair of fixing holes via the first fixing member.

According to the configuration, the first light source module can be fixed to the support member after the first light source module is positioned with respect to the support member. Since the pair of through holes and the pair of fixing holes are formed with the center of the first light source in between, the first light source module can be stably fixed to the support member. Therefore, the positioning accuracy is improved.

### Appendix 7

The optical module according to any one of Appendices 1 to 6, further includes a heat dissipation member that dissipates heat of the first light source of the first light source module, wherein the first substrate includes a first surface on which the first light emitting element is mounted and a second surface opposite to the first surface, and the heat dissipation member is in contact with the second surface of the first substrate.

According to the configuration, the heat dissipation member can be disposed in contact with the back surface of the first substrate on which the first light emitting element that generates heat is provided. Therefore, the heat generated from the first light emitting element can be efficiently dissipated.

### Appendix 8

In the optical module according to Appendix 7, the heat dissipation member includes a first through hole through which a second fixing member is inserted, the first substrate includes a second through hole through which the second fixing member is inserted with the first through hole, the holding member includes a fixing hole formed at the first substrate side, and the heat dissipation member is fastened and fixed to the holding member by the second fixing member with the first substrate sandwiched between the holding member and itself.

According to the configuration, the heat dissipation member is directly fixed to the holding member with the first substrate sandwiched. Therefore, the number of components for attaching the heat dissipation member can be reduced.

### Appendix 9

An optical module includes a first light source module having a first light source that emits a first light, a support member that supports the first light source module, and a first light modulation unit that modulates the first light incident from the first light source module, wherein the first light source module has a first light source including a first light emitting element that emits the first light, and a first substrate on which the first light emitting element is mounted, and a holding member fixed to the first substrate, the holding member has an attachment portion that extends along a surface direction of the first substrate and attaches the first light source module to the support member, the attachment portion includes an attachment surface in contact with the support member, the support member has a fixing surface in contact with the attachment surface, to which the first light source module is fixed, and the holding member and the support member are directly fixed to each other via the attachment surface and the fixing surface.

According to the light source module having the configuration, the attachment surface of the holding member and the fixing surface of the support member are directly fixed. Accordingly, relative position adjustment and fixing of the holding member and the support member can be easily performed. Thus, the position of the support member can be adjusted with high accuracy with respect to the first light source module. Therefore, since the optical axis of the first light source and the optical axis of the support member can be aligned with each other, the light use efficiency can be improved. In addition, since the number of interposed members is reduced, a deviation due to tolerance can be suppressed.

### Appendix 10

A projector includes the optical module according to any one of Appendices 1 to 9.

According to the projector having the configuration, it is possible to provide a projector capable of improving light use efficiency.

What is claimed is:

1. An optical module comprising:
a first light source module having a first light source that emits a first light;
a support member that supports the first light source module;
a positioning portion that positions the first light source module with respect to the support member; and
a first light modulation unit that modulates the first light incident from the first light source module, wherein
the first light source module has
a first light source including a first light emitting element that emits the first light, and a first substrate on which the first light emitting element is mounted, and
a holding member fixed to the first substrate,
the holding member has an attachment portion that extends along a surface direction of the first substrate and attaches the first light source module to the support member,
the attachment portion has an attachment surface in contact with the support member,
the support member has a position adjustment surface in contact with the attachment surface for adjusting a relative position between the first light source module and the support member,
the positioning portion includes a first opposing portion provided on the attachment surface and a second opposing portion provided at a position corresponding to the first opposing portion on the position adjustment surface, and
when the relative position between the first light source module and the support member is determined, the first opposing portion and the second opposing portion at least partially overlap each other when viewed in a direction along an optical axis direction of the first light.

2. The optical module according to claim 1, further comprising:
a second light source module having a second light source including a second light emitting element that emits a second light in a wavelength band different from that of the first light, and a second substrate on which the second light emitting element is mounted;
a third light source module having a third light source including a third light emitting element that emits a third light in a wavelength band different from those of the first light and the second light, and a third substrate on which the third light emitting element is mounted;
a second light modulation unit that modulates the second light incident from the second light source; and
a third light modulation unit that modulates the third light incident from the third light source, wherein
the support member further supports the second light source module and the third light source module,
the first light source module supported by the support member is disposed to face the first light modulation unit,
the second light source module supported by the support member is disposed to face the second light modulation unit, and
the third light source module supported by the support member is disposed to face the third light modulation unit.

3. The optical module according to claim 2, further comprising a light combining element that combines the light emitted from the first light modulation unit, the light emitted from the second light modulation unit, and the light emitted from the third light modulation unit, wherein
the support member has
a first fixing section that fixes the first light source module,
a second fixing section that fixes the second light source module,
a third fixing section that fixes the third light source module,
a first coupling portion that couples the first fixing section and the second fixing section at the light combining element side, and
a second coupling portion that couples the first fixing section and the third fixing section at the light combining element side, and
the first fixing section, the second fixing section, and the third fixing section are disposed to surround the light combining element.

4. The optical module according to claim 1, wherein
the support member has a first fixing section that fixes the first light source module,
the first fixing section includes a housing portion that opens along the optical axis of the first light and houses at least a part of the first light source module, and
the housing portion is located at an emission side of the first light with respect to the position adjustment surface and has a peripheral wall portion protruding toward a light incident side in a direction along the optical axis of the first light in at least a part of a peripheral edge portion in the position adjustment surface.

5. The optical module according to claim 1, wherein
the first opposing portion and the second opposing portion are respectively disposed in a diagonal direction of the first substrate,
the first opposing portion is provided with a pair of hole portions for inserting a jig for determining the relative position between the first light source module and the support member, and
the second opposing portion is provided with a pair of receiving portions for receiving the jig at positions corresponding to the pair of hole portions.

6. The optical module according to claim 1, wherein
the attachment portion has a pair of through holes formed in the attachment surface with a center of the first light source in between,
the position adjustment surface has a pair of fixing holes to which a first fixing member for fixing the holding member is fixed formed at positions corresponding to the pair of through holes, and
the first light source module is fixed to the support member by respectively coupling the pair of through holes and the pair of fixing holes via the first fixing member.

7. The optical module according to claim 1, further comprising a heat dissipation member that dissipates heat of the first light source of the first light source module, wherein
the first substrate includes a first surface on which the first light emitting element is mounted and a second surface opposite to the first surface, and
the heat dissipation member is in contact with the second surface of the first substrate.

8. The optical module according to claim 7, wherein
the heat dissipation member includes a first through hole through which a second fixing member is inserted,
the first substrate includes a second through hole through which the second fixing member is inserted with the first through hole,
the holding member includes a fixing hole formed at the first substrate side, and
the heat dissipation member is fastened and fixed to the holding member by the second fixing member with the first substrate sandwiched between the holding member and itself.

9. An optical module comprising:
a first light source module having a first light source that emits a first light;
a support member that supports the first light source module; and
a first light modulation unit that modulates the first light incident from the first light source module, wherein
the first light source module has
a first light source including a first light emitting element that emits the first light, and a first substrate on which the first light emitting element is mounted, and
a holding member fixed to the first substrate,
the holding member has an attachment portion that extends along a surface direction of the first substrate and attaches the first light source module to the support member,
the attachment portion includes an attachment surface in contact with the support member,
the support member has a fixing surface in contact with the attachment surface, to which the first light source module is fixed, and
the holding member and the support member are directly fixed to each other via the attachment surface and the fixing surface.

10. A projector comprising the optical module according to claim 1.
